(19) United States
(12) Patent Application Publication
(10) Pub. No.: US 2022/0077726 A1
(43) Pub. Date: Mar. 10, 2022

(54) ELECTRIC MACHINE STATOR WITH A RING FORMED BY A PLURALITY OF STATOR SEGMENTS

(71) Applicant: IFP Energies nouvelles, Rueil-Malmaison (FR)

(72) Inventors: Fabrice LE BERR, RUEIL-MALMAISON CEDEX (FR); Misa MILOSAVLJEVIC, RUEIL-MALMAISON CEDEX (FR); Denis GROSJEAN, RUEIL-MALMAISON CEDEX (FR); Baptiste CHAREYRON, RUEIL-MALMAISON CEDEX (FR); Abdenour ABDELLI, RUEIL-MALMAISON CEDEX (FR); Benjamin GAUSSENS, RUEIL-MALMAISON CEDEX (FR); Christophe DUFRESNES, RUEIL-MALMAISON CEDEX (FR)

(21) Appl. No.: 17/413,300

(22) PCT Filed: Nov. 26, 2019
(86) PCT No.: PCT/EP2019/082608

§ 371 Date: Jun. 11, 2021

(30) Foreign Application Priority Data
Dec. 11, 2018 (FR) 1872688

(51) Int. Cl. H02K 1/14; H02K 15/02

(52) U.S. Cl. CPC H02K 1/148; H02K 15/022

(57) ABSTRACT

The present invention is an electrical machine stator comprising a crown (12) and a cylindrical support (7). Crown (12) is an assembly of stator segments (1) having the shape of a T, having a vertical leg (2) forming a stator tooth. Cylindrical support (7) comprises radial orifices (14) for passage of the vertical leg of the T of the stator segments.

### CROSS-REFERENCE TO RELATED APPLICATIONS

This application is a National Stage Application of PCT/EP2019/082608, filed Nov. 26, 2019, which claims priority to French Patent Application No. 18/72.688, filed Dec. 11, 2018, the contents of which are incorporated herein by reference in their entirety.

### BACKGROUND OF THE INVENTION

### Field of the Invention

The present invention relates to a stator of a rotary electrical machine.

### Description of the Prior Art

Generally, such an electrical machine comprises a stator and a rotor coaxially arranged to one another.

The rotor has a rotor body carrying magnetic flux generators, such as permanent magnets or windings.

This rotor is generally housed within the stator that carries magnetic flux generators in the form of electrical windings (or armature windings) for generating a magnetic field allowing the rotor to be driven in rotation in combination with the magnetic field generated by at least one of the magnets and the windings of the rotor.

The stator conventionally comprises radial slots extending in the direction of the rotor and extending all along the circumference of the stator. These slots receive the armature windings that are fastened thereto by any known mechanism.

Depending on at least one of the application of the electrical machine and for its cooling, it may be desirable to flow a fluid through the electrical machine.

Within this known type of electrical machine with a large air gap between the rotor and the stator, an air gap may be several centimeters long which allows passage of a gaseous or liquid fluid therethrough.

This type of electrical machine is notably known from US published patent application 2008/289,333, US2013/169,074 and US2013/043,745 for synchro-reluctant machines with large air gaps operating at low speed, to have large air gap allowing a fluid to be driven therethrough.

However, this large air gap is a drawback which interferes with passage of the magnetic flux between the rotor and the stator and which limits the intrinsic efficiency of the electrical machine and for the size of the stator having the same power output.

In order to overcome the aforementioned drawbacks, an electrical machine has been developed with a small air gap which permits passage of fluid through the machine, between the stator teeth which allows better energy conversion between the stator and the rotor. This type of electrical machine which is referred to as stator grid machine, is disclosed in French patent application FR-3,041,831 (US published patent application 2018/269,744).

This type of electrical machine is notably satisfactory because the radial passages of the stator are delimited on either side by teeth which transmit the stator flux and guide the fluid through the electrical machine. It is however desirable to facilitate and automate production of the winding. Indeed, for some applications, for example with the electrification of supercharger components with rotors of very small diameter (less than 20 mm) which operate at very high speed (above 150,000 rpm), the diameter at the stator foot is small equivalent to the rotor diameter plus twice the thickness of the mechanical air gap, which is very small for a small air gap electrical machine, the stator teeth therefore have feet that are very close together and sometimes touch within closed slots. This configuration makes winding very difficult, requiring a pull-in (closed slots) or insertion (open slots) method. Furthermore, these small spaces between the teeth also constrain the wire diameter and the number of parallel strands that make up the coil, which is inserted into the stator. Winding automation then becomes very complex and therefore expensive for stators of this type.

Furthermore, there are also known stators of electrical machines having an assembly of stator segments. These stator designs allow simple stator elements to be produced. For example, US patent application 2009/072,647 and U.S. Pat. No. 8,129,880 and Chinese patent 106,712,326 describe such stators. However, these stators do not enable simple stator winding a diametral pitch winding. Indeed, these patent applications relate to electrical machines for which the winding is a tooth winding or a concentric winding.

### SUMMARY OF THE INVENTION

To overcome these drawbacks, the present invention relates to an electrical machine stator comprising a crown and a cylindrical support. The crown is an assembly of a stator segments having the shape of a T having a the vertical leg of which forms a stator tooth. The cylindrical support comprises radial orifices for passage of the vertical leg of the T of the stator segments. The cylindrical support allows the winding to be simplified, indeed, with this stator design, winding can be achieved around the cylindrical support prior to inserting the stator segments. In addition, segmentation of the crown allows production of simple standard stator elements and filtering magnetic field harmonics in the ferromagnetic parts, thus providing a reduction in iron losses.

The invention further relates to an electrical machine, an electrified compressor, an electrified turbine and an electrified turbocharger using such a stator. The invention additionally relates to a method of manufacturing such a stator.

The invention thus relates to an electrical machine stator comprising a crown of stator segments, the stator segments being substantially T shaped, the vertical leg of the T forming a radial tooth of the stator and delimiting the slots of the stator which receive windings. The stator further comprises a cylindrical support having radial orifices for insertion of the vertical leg of the T of the stator segments.

According to one embodiment, the cylindrical support is made from an a magnetic material.

Advantageously, the stator segments are made from a ferromagnetic material.

According to one implementation, the cylindrical support comprises means for separating the slots of the stator, which projects from the outer surface of the cylindrical support.

According to an aspect of the invention, the cylindrical support comprises at least one aerodynamic appendage.

Preferably, the aerodynamic appendages comprise aerodynamic sections arranged at least on one side of the vertical leg of the T of the stator segments.

Advantageously, the aerodynamic appendage comprises a central ogive.

According to a feature, the winding is arranged between the cylindrical support and the crown made up of the plurality of stator segments.

According to an embodiment, the stator further comprises a tubular sleeve connected to the end of the vertical leg of the T of the stator segments.

According to an aspect, the stator further comprises a yoke around the crown made from the stator segments.

Furthermore, the invention relates to an electrical machine comprising a rotor and a stator according to one of the above features.

The invention also relates to an electrical compressor comprising an electrical machine according to one of the above features driving a compressor, which preferably causes the fluid which is compressed to flow through the stator of the electrical machine.

The invention also relates to an electrical turbine comprising an electrical machine according to one of the above features which is driven by a turbine.

In addition, the invention relates to an electrical turbocharger comprising an electrical machine according to one of the above features, connected to a turbocharger, in which preferably the fluid which is intended to be compressed by the compressor of the turbocharger flows through the stator of the electrical machine.

Moreover, the invention relates to a method of manufacturing an electrical machine stator according to one of the above features, wherein the following steps are carried out:

a) performing winding of the stator on an outer part of a cylindrical support or of an elastic plane support;

b) inserting the stator segments into the radial orifices of the cylindrical support, and

c) forming the crown by assembling the stator segments.

According to an embodiment, the method comprises an additional step of fastening a tubular sleeve to an end of the vertical leg of the T of the stator segments.

According to an implementation, the method comprises an additional step of inserting the crown into a yoke.

According to an aspect, the crown is formed by assembling the stator segments and by deforming the elastic plane support.

### BRIEF DESCRIPTION OF THE DRAWINGS

Other features and advantages of the device and of the method according to the invention will be clear from reading the description hereafter of embodiments, given by way of non limitative example, with reference to the accompanying figures wherein:

FIG. 1 illustrates a stator segment according to an embodiment of the invention.

FIG. 2 illustrates the arrangement of the stator segments before assembly according to an embodiment of the invention.

FIG. 3 illustrates a crown or ring made from stator segments according to an embodiment of the invention.

FIG. 4 illustrates a cylindrical support according to an embodiment of the invention.

FIG. 5 illustrates a stator according to an embodiment of the invention before assembly of the stator segments.

### DETAILED DESCRIPTION OF THE INVENTION

The invention relates to a stator of an electrical machine comprising a rotor and a stator. The stator comprises radial passages, also referred to as slots, circumferentially arranged along the stator. The radial passages are delimited by radial teeth. Magnetic flux generators (preferably windings) are housed in the radial passages. Furthermore, the radial passages (slots) include fluid circulation galleries opposite the magnetic flux generators (windings). Moreover, the stator has a central bore in which the rotor rotates. The fluid is a gas which is, preferably air.

According to the invention, the stator comprises a crown or ring and a cylindrical support.

The crown or ring has a circumferential assembly of stator segments. The stator segments substantially have the shape of a T (in three dimensions, that is with a thickness). When the stator segments are assembled to form the crown or ring, the vertical leg of the T is directed towards the center of the stator to form a radial tooth of the stator. The radial teeth of the stator delimit the slots, which include the magnetic flux generators and the fluid circulation galleries. In an assembled position, the horizontal leg of the T forms the outer part of the crown. This design of the crown with stator segments allows simplification and standardizing of the manufacture (simple T shape) while minimizing material waste, which minimizes the cost of raw material. Furthermore, segmentation of the stator allows filtration of some of the magnetic field harmonics in the ferromagnetic parts which reduce iron losses and improves the efficiency of the electrical machine. According to an aspect of the invention, the horizontal leg of the T can be curved (concave) so that the circumferential assembly of the plurality of stator segments forms a cylindrical outer surface. According to an alternative, the horizontal leg of the T can be rectilinear. For this variant, the circumferential assembly of the stator segments forms a polygonal outer surface.

According to an embodiment of the invention, the ends of the horizontal leg of the T can comprise sections for assembly of the stator segments. For example, one end of the horizontal leg of the T can be convex and the other end of the horizontal leg of the T can be concave, with a concavity that is adapted to cooperate with the convex part of a neighbouring stator segment and vice versa. Alternatively, the ends of the horizontal leg of the T can have any other shape providing cooperation of two consecutive segments.

According to an embodiment of the invention, the crown or ring can have a substantially cylindrical outer surface, which allows limitation of the overall size of the stator. However, the crown or ring may have other shapes.

Advantageously, the stator segments can be made of a ferromagnetic material to efficiently conduct the magnetic flux from the magnetic flux generators (winding) towards the rotor.

Preferably, the stator segments can be made by stacking sheets. Thus, every sheet has substantially the shape of a thin T and the stator segment is a stack of sheets having substantially the shape of a T. This design allows magnetic losses in the stator to be limited.

According to an embodiment of the invention, the crown comprises six stacked stator segments, which may correspond to the number of poles (minimum one pair of poles) multiplied by the number of phases of the electrical machine (generally three).

Advantageously, the vertical legs of the T shaped stator segments are of a length so that the slots formed by the assembly of stator segments is sufficient to provide a location for the windings and a gallery location for the fluid flow in the stator.

The cylindrical support comprises radial orifices for insertion of the vertical leg of the T of the rotor segments. Furthermore, the cylindrical support supports the winding which preferably is on the outer surface thereof. The cylindrical support thus enables positioning and guiding of the stator segments, which facilitates mounting of the stator. Thus, winding is facilitated; since the support is not part of the stator teeth. There is no space or size constraint for carrying out the winding step. Automated winding is possible with this stator design. Moreover, the cylindrical support allows the slots to be separated into two zones which are one for the windings and the other for the fluid circulation galleries (which are preferably inside the cylindrical support).

The cylindrical support can be made of an amagnetic material which has no function for the circulation of magnetic fluxes and prevents passage of magnetic flux into the stator tooth. It can for example be made of a polymer material or an amagnetic metal. Advantageously, the cylindrical support can be made by moulding, plastic or pressure injection, or additive manufacturing.

According to an aspect of the invention, the cylindrical support can be made in one piece. Alternatively, the cylindrical support can be made of two parts which each part having a cylindrical shape. The two parts are assembled along a plane perpendicular to the axis of the cylindrical support.

According to an embodiment of the invention, the cylindrical support can further comprise means for separating the slots. The separation means can be evenly distributed. Preferably, a separation means can be provided for each slot of the stator. The slot separation means can project from the outer surface of the cylindrical support. The separation means are intended to promote winding on the cylindrical support. According to an embodiment of the invention, the separation means can be a wall projecting from the outer surface of the cylindrical support in a substantially radial direction. Advantageously, the separation means can be located in the middle, in the circumferential direction, of two radial orifices for insertion of the stator segments to create identical spaces.

According to an implementation of the invention, the cylindrical support can also comprise at least one aerodynamic appendage for guiding the fluid towards/from the fluid circulation galleries. According to an aspect of the invention, the aerodynamic appendages can be made of aerodynamic sections arranged at least on one side of the stator teeth, which is beside the vertical leg of the T of the stator segments. Alternatively or additionally, the aerodynamic appendage can be a central ogive covering the central bore of the stator intended to receive the rotor, the fluid being thus guided towards the stator without passing through the rotor or the air gap. Alternatively or additionally, the aerodynamic appendage can be a longitudinal extension of the cylindrical support so the cylindrical support can extend at least on one side of the stator to guide the fluid in the slots.

According to a feature of the invention, the stator can further comprise a central tubular sleeve in which the rotor of the electrical machine rotates. The tubular sleeve is connected to the end of the vertical leg of the T of the stator segments which allows closing of the slots to limit magnetic and aerodynamic losses contribution to the mechanical strength of the stator which notably to the crown or ring of the stator teeth. The tubular sleeve can be made of a magnetic or amagnetic material.

Alternatively, the stator does not have a central tubular sleeve so the stator is then an open-slot stator.

According to an embodiment of the invention, the cylindrical support can be made initially from a substantially plane elastic support initially substantially shaped as a strip. The elastic plane support is intended to form the cylindrical support from deformation after assembly of the components of the stator.

In order to hold together the stator segments, the stator can comprise an outer yoke positioned around the crown formed by the rotor segments.

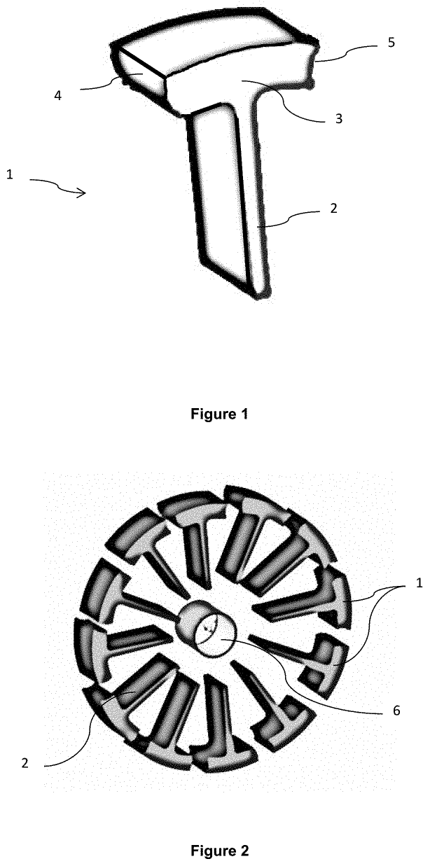

FIG. 1 schematically illustrates, by way of non limitative example, a stator segment 1 according to an embodiment of the invention. Stator segment 1 substantially has the shape of a T, with a vertical leg 2, configured to form a stator tooth, and a horizontal leg 3 configured to form the crown or ring by assembling of multiple stator segments 1. For the illustrated embodiment, horizontal leg 3 is curved. To achieve this assembly, horizontal leg 3 has a concave end 4 and a convex end 5 which respectively cooperate with a convex end and a concave end of other stator segments. The outer surface of stator segment 1 is domed to form a circular crown once the stator segments assembled.

FIG. 2 schematically illustrates, by way of non-limitative example, the arrangement of stator segments 1 prior to assembly according to an embodiment of the invention. In this figure, the cylindrical support and the windings are not shown. For the embodiment as illustrated, the stator teeth (vertical legs 2 of FIG. 1) are designed to be linked to a central sleeve 6. In this position, stator segments 1 are prepositioned prior to being assembled. For the embodiment illustrated, horizontal leg 3 is curved.

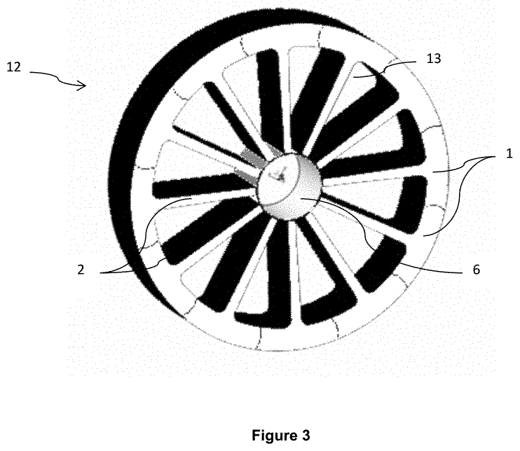

FIG. 3 schematically illustrates, by way of non-limitative example, the arrangement of stator segments 1 after assembly according to an embodiment of the invention. FIG. 3 corresponds to the embodiment of FIG. 2. In this figure, the cylindrical support and the windings are not shown. This figure shows crown 12 of the stator. Crown 12 is an assembly of twelve stator segments 1. Stator segments 1 are assembled at the ends of the vertical leg of the T (ends 4 and 5 of FIG. 1). Furthermore, vertical legs 2 of the stator segments 1 form stator teeth delimiting of defining slots 13. The slots are provided for the windings and for the fluid circulation galleries. For the illustrated embodiment, the stator teeth (vertical legs 2 in FIG. 1) are connected to a central sleeve 6. For the illustrated embodiment, horizontal leg 3 of stator segments 1 is curved. Thus, the outer surface of the stator is cylindrical.

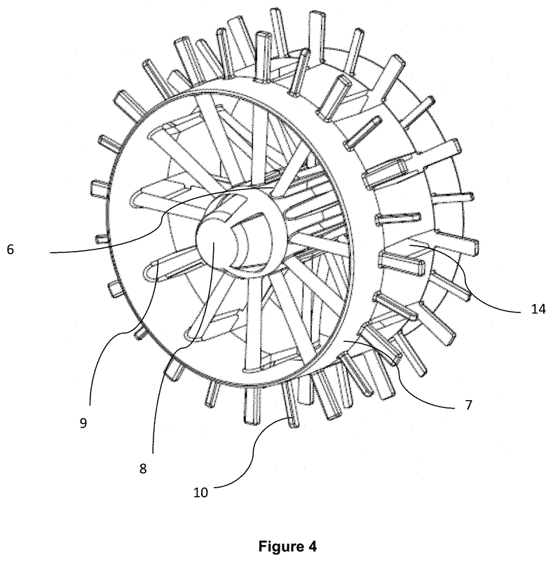

FIG. 4 schematically illustrates, by way of non-limitative example, a cylindrical support 7 according to an embodiment of the invention. In this figure, the stator segments and the coils are not shown. Cylindrical support 7 has an overall cylindrical shape and it comprises radial orifices 14 in which the vertical legs of the T of the stator segments are inserted. Cylindrical support 7 also comprises aerodynamic appendages. The aerodynamic appendages have a central ogive 8 covering a central tubular sleeve 6. The aerodynamic appendages further have aerodynamic sections 9 arranged over the height of the stator teeth, which is over the height of the vertical leg of the stator segments. Aerodynamic sections 9 are fastened to tubular sleeve 6. Preferably, aerodynamic sections are provided on either side of the stator teeth (i.e. the vertical legs of the stator segments). The aerodynamic sections project from the outer face of cylindrical support 7, notably to facilitate guidance of the vertical legs of the stator segments. Furthermore, cylindrical support 7 comprises walls 10 projecting from the outer surface thereof so as to form slot separations or means. Walls 10 have a substantially radial direction and they are arranged circumferentially in the middle of two radial orifices for insertion of the stator segments. The winding is intended to be positioned around walls 10.

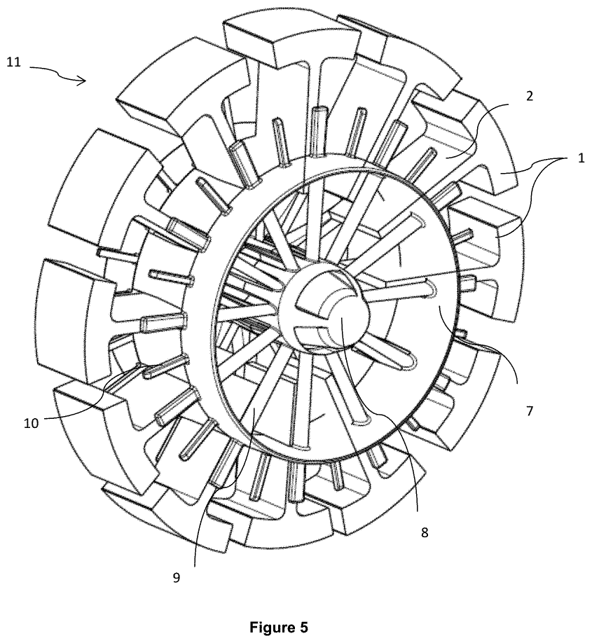

FIG. 5 schematically illustrates, by way of non-limitative example, the arrangement of stator segments 1 prior to assembly according to an embodiment of the invention, for forming a stator 11. FIG. 5 corresponds to FIG. 2 with the representation of cylindrical support 7. In this figure, the winding is not shown. Cylindrical support 7 comprises radial orifices in which the vertical legs of the T of stator segments 1 are inserted. In this position, stator segments 1 are prepositioned prior to being assembled. Cylindrical support 7 further comprises aerodynamic appendages. The aerodynamic appendages have a central ogive 8 covering the central sleeve. The aerodynamic appendages further have aerodynamic sections 9 arranged over the height of the stator teeth, i.e. over the height of vertical leg 2 of the stator segments. Furthermore, cylindrical support 7 comprises walls 10 projecting from the outer surface thereof so as to form slot separations or slot separation means. Walls 10 have a substantially radial direction and they are arranged circumferentially in the middle of two radial orifices for insertion of the stator segments. The windings are intended to be positioned in the space contained between cylindrical support 7 and the crown or ring and around walls 10.

The invention also relates to an electrical machine comprising a stator according to any one of the variant combinations described above and a rotor. The rotor is arranged coaxially to the stator and rotates within the stator by being driven by the magnetic field formed by the windings.

Preferably, the electrical machine is a stator grid machine, as described notably in French patent application 3,041,831 (US patent application 2018/269,744). This design notably allows the windings to be positioned at a distance from the rotor.

By way of example only, this machine can be a one-pole-pair synchronous machine.

This does not in any way exclude any other type of electrical machine, such as synchronous machines with more than one pole pair, or wound-rotor or squirrel-cage-rotor asynchronous machines, reluctant machines and synchro-reluctant machines.

Due to its intrinsic advantages related to the geometry thereof, enabling the stator to be traversed by a fluid and to position the stator flux generators radially away from the rotor flux generators, this type of machine can be easily integrated into an existing system with minor integration-related modifications.

According to an example embodiment of the invention, the electrical machine can be compactly combined with a compressor in an electrical compressor, electrical turbine or electrical turbocharger architecture. This compactness is pertinent when the system must operate at very high engine speed, which requires reducing to the maximum the length and the mass/inertia of the rotating shafts.

Advantageously, when the electrical machine is combined with a compressor or a turbocharger, the electrical machine can be arranged upstream from the compressor in such a way that the fluid used by the compressor consecutively circulates in the stator of the electrical machine, then in the compressor. This configuration provides a compact design and it allows the electrical machine to be cooled without any additional fluid circulation line.

Furthermore, the invention relates to a method of manufacturing a stator of an electrical machine according to any one of the aforementioned variant combinations. The manufacturing method can be implemented from a preformed cylindrical support or from a substantially plane elastic support (strip). For this manufacturing method, the following steps are carried out:

a) performing winding of the stator on an outer part of a cylindrical support or an elastic plane support;

b) inserting the stator segments into the radial orifices of the cylindrical support; and

c) forming the crown or ring by assembling the stator segments.

Thus, the manufacturing method provides simple winding, enabling automation of this step. Furthermore, the stacked sheets of iron which form the stator and the winding can be operated by different entities on different geographical sites. In addition, the method according to the invention allows the complexity and the cost of the process to be reduced.

For the embodiment wherein the method is carried out from an elastic plane support, step c) can be performed by forming a cylindrical support by deformation of the plane support equipped with the winding and the stator segments. The elastic plane support then becomes the cylindrical plane support. This embodiment facilitates winding and assembly of the stator components.

According to an embodiment of the invention, wherein the cylindrical support comprises a slot separation or slot separation means, the stator winding can be achieved around the separation or slot separation means.

According to an implementation of the invention, wherein the stator comprises a central sleeve, the manufacturing method can comprise an additional step of fastening the vertical legs of the T of the stator segments to the tubular sleeve.

According to an aspect of the invention, wherein the stator comprises a yoke, the method according to the invention can comprise an additional step of inserting the crown into the yoke.

FIG. 5 corresponds to the end of step b) of the method according to the invention wherein the cylindrical support is initially formed prior to step a).

1-18. (canceled)

19. An electrical machine stator comprising a ring formed from stator segments each substantially having a T shape, a vertical leg of the T shape forming a radial tooth of the stator and forming slots of the stator for receiving windings, wherein the stator further comprises a cylindrical support comprising radial orifices for receiving insertion of vertical leg of the T shape of the stator segments.

20. An electrical machine stator as claimed in claim 19, wherein the cylindrical support comprise an amagnetic material.

21. An electrical machine stator as claimed in claim 19, wherein the stator segments comprise a ferromagnetic material.

22. An electrical machine stator as claimed in claim 19, wherein the cylindrical support comprises means for separating the slots of the stator which projects from an outer surface of the cylindrical support.

23. An electrical machine stator as claimed in claim 19, wherein the cylindrical support comprises at least one aerodynamic appendage.

24. An electrical machine stator as claimed in claim 23, wherein the at least one aerodynamic appendage comprises aerodynamic sections positioned at least on one side of the vertical leg of the T shaped stator segments.

25. An electrical machine stator as claimed in claim 23, wherein the at least one aerodynamic appendage has a central ogive.

26. An electrical machine stator as claimed in claim 24, wherein the at least one aerodynamic appendage has a central ogive.

27. An electrical machine stator as claimed in claim 19, wherein the winding is positioned between the cylindrical support and the ring formed from the stator segments.

28. An electrical machine stator as claimed in claim 19, wherein the stator comprises a tubular sleeve connected to an end of the vertical leg of the T shaped stator segments.

29. An electrical machine stator as claimed in claim 19, wherein the stator comprises a yoke around the ring of the T shaped stator segments.

30. An electrical machine comprising a rotor and a stator as claimed in claim 19.

31. A combination of an electrical compressor and an electrical machine as claimed in claim 30, wherein the electrical machine driving the compressor, wherein, the fluid compressed by the compressor flows through the stator of the electrical machine.

32. A combination of an electrical turbine and an electrical machine as claimed in claim 30, wherein the electrical machine is driven by the turbine.

33. A combination of an electrical turbocharger and an electrical machine as claimed in claim 30, wherein the electrical machine is connected to the turbocharger, with a fluid compressed by the compressor of the turbocharger flows through the stator of the electrical machine.

34. A method of manufacturing of a stator of an electrical machine stator as claimed in claim 19, comprising steps of:
a) performing the winding of the stator on an outer part of the cylindrical support or of an elastic plane support;
b) inserting the stator segments into the radial orifices of the cylindrical support; and
c) forming the ring by assembling the stator segments.

35. A method of manufacturing an electrical machine stator as claimed in claim 34, wherein the method comprises fastening a tubular sleeve onto an end of vertical leg of the T shaped stator segments.

36. A method of manufacturing an electrical machine stator as claimed in claim 34, wherein the method comprises inserting the ring into a yoke.

37. A method of manufacturing an electrical machine stator as claimed in claim 35, wherein the method comprises inserting the ring into a yoke.

38. A method of manufacturing an electrical machine stator as claimed in claim 34, wherein the ring is formed by assembling stator segments and deforming the elastic plane support.
